(19) United States
(12) Patent Application Publication
(10) Pub. No.: US 2015/0306630 A1
(43) Pub. Date: Oct. 29, 2015

(54) METHOD FOR INSULATING A HONEYCOMB CATALYST

(71) Applicant: Maurice Lacasse, Sherbrooke (CA)

(72) Inventor: Maurice Lacasse, Sherbrooke (CA)

(21) Appl. No.: 14/261,048

(22) Filed: Apr. 24, 2014

(51) Int. Cl. B05D 7/22; B05D 3/02; B05D 7/24; B05D 1/40

(52) U.S. Cl. CPC B05D 7/22; B05D 1/40; B05D 3/0254; B05D 7/24

(57) ABSTRACT

The method is for use with a substrate having a plurality of parallel channels extending therethrough. In the method, the steps comprise: filling a selected plurality of the channels with a granular material; and consolidating the granular material through heat. The selected plurality of channels is selected to produce a wall that separates the substrate into: a first portion having a first plurality of the parallel channels extending therethrough; and a second portion having a second plurality of the parallel channels extending therethrough.

### BACKGROUND OF THE INVENTION

1. Field of the Invention

The invention relates to the field of insulated honeycomb catalysts.

2. Prior Art

It is known to divide a honeycomb catalyst through the use of a wall or walls of insulation, as taught in PCT/CA2009/001187.

### SUMMARY OF THE INVENTION

Forming one aspect of the invention is a method for use with a substrate having a plurality of parallel channels extending therethrough, the method comprising the steps of: filling a selected plurality of the channels with a granular material; and consolidating the granular material through heat, the selected plurality being arranged to produce a wall that separates the substrate into: a first portion having a first plurality of the parallel channels extending therethrough; and a second portion having a second plurality of the parallel channels extending therethrough.

According to another aspect of the invention, the consolidation step can be a sintering step.

According to another aspect, the granular material can consist essentially of: from 67 to 96% by weight of fly-ash comprising cenospheres; from 2 to 15% by weight of a heat sensitive binder selected from the group consisting of boric acid and anhydrous boron oxide; from 2 to 7% by weight of a non-wetting agent selected from the group consisting of calcium fluoride, magnesium fluoride and barium sulphate; from 0 to 10% by weight of a heat expandable material selected from the group consisting of vermiculite and graphite; and from 0 to 1% by weight of a dust suppressant.

According to another aspect, the granular material can consist essentially of: from about 89.5 to 90% by weight of said fly ash; about 8% by weight of said heat sensitive binder; about 2% by weight of said non-wetting agent; and from about 0 to 0.5% by weight of said dust suppressant.

According to another aspect, said binder can be boric acid.

According to another aspect, the granular material can contain 2 to 5 wt % of calcium fluoride.

According to another aspect, the granular material can have a density of from 25 to 30 lb/ft³.

According to another aspect of the invention, the granular material can have a median particle size of approximately 50 microns and a particle size ranging from 10 to 160 microns.

According to another aspect of the invention, the filling step can involve pouring the granular material into the plurality of the cells.

According to another aspect of the invention, the substrate can be vibrated during the filling process.

According to another aspect of the invention, the vibration to which the substrate is subjected to during the filling step can have an amplitude of about 10 millimeters and a speed of about 3 inch per second RMS.

Further advantages and characteristics of the present invention will become apparent upon review of the following detailed description and the appended drawings, the latter being briefly described hereinafter.

### BRIEF DESCRIPTION OF THE DRAWINGS

FIG. 1 is a plan view of a mask used in an exemplary embodiment of the method; and

FIG. 2 is a side view of the mask of FIG. 1.

### DETAILED DESCRIPTION OF THE PREFERRED EMBODIMENTS

The exemplary embodiment of the method is carried out with a conventional honeycomb substrate of the type that is extruded from cordierite, cured at high temperature and has a plurality of parallel channels extending therethrough.

This method comprises a filling step, a consolidation step and a sealing step.

In the filling step, a selected plurality of the channels are filled with a granular material, the selected plurality of channels being selected to lie within and substantially occupy a notional wall that separates the substrate into a first portion having a first plurality of the parallel channels extending therethrough and a second portion having a second plurality of the parallel channels extending therethrough.

A suitable granular material has the composition described in U.S. Pat. No. 7,083,758, incorporated herein by reference, and has a median particle size of approximately 50 microns and a particle size ranging from 10 to 160 microns.

To accomplish the filling, one of the parallel faces of the substrate is placed upon a rubber seal, an aluminum mask having a slit defined therethrough is placed upon the opposing face such that the slit lies upon the notional wall and granular material is poured upon the mask while the mask, honeycomb substrate and seal are vibrated as a unit with a vibration having an amplitude of about 10 millimeters and a speed of about 3 inch per second RMS.

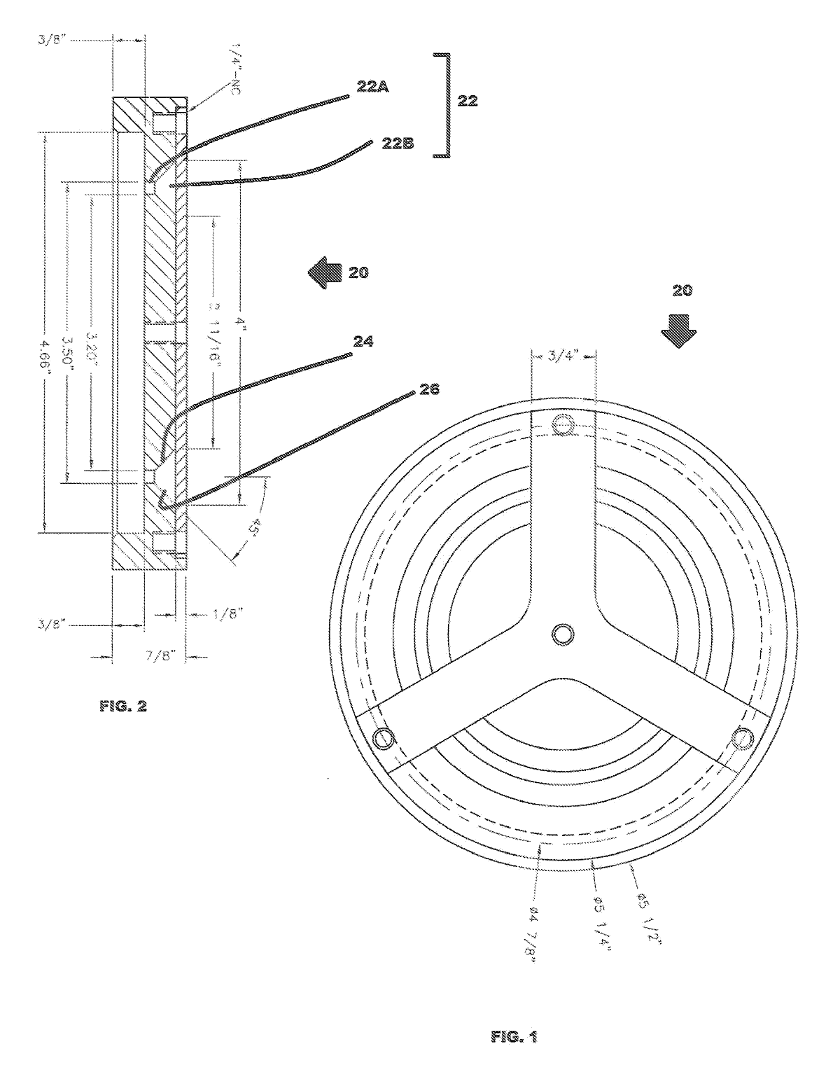

A suitable mask 20 in shown in FIG. 1 and FIG. 2 and will be seen to have a slit 22 having a narrow [0.15″ thick] bottom 22A and a broad [17/32″] top 22B, thereby defining an elongate funnel adapted such that granular material poured upon the mask is directed towards the interior of the notional wall. Use of this mask in the manner contemplated above provides for relatively quick filling of both 900 cpi and 400 cpi bricks; for example, conventional 4.23″ high bricks can be filled in 30 seconds.

In the consolidation step, the granular material is heat sintered to produce a wall of insulation corresponding in size to the notional wall. It has been found that a suitable sintering regime involves elevating the temperature of the granular material to 800° C. at a rate of 200° C./hour and then allowing the heated product to cool to ambient temperature at 200° C./hour.

In the sealing step, the ends of the insulated wall are sealed with a material that is adapted to reduce absorption of the catalyst in any subsequent wash coating step carried out on the substrate/wall combination and that is ideally adapted to dissipate during the curing of the catalyst coating. Selection of a sealant suitable for this purpose is a matter of routine for persons of ordinary skill in the art and accordingly further detail is neither provided nor described. The result of the sealing step is the production of an insulated catalytic substrate as described in PCT/CA2009/001187. Such an insulated substrate can be wash coated with a catalyst in any conventional manner. Washcoating forms no part of the present invention and thus is not further described.

Whereas but a single embodiment is herein described in detail, variations are possible.

For example, whereas a specific granular material is described, it is contemplated that other materials might be utilized.

As well, whereas a specific mask is shown, other masks can be utilized. For example, whereas the elongate funnel shown has primary walls 24,26 disposed at 90° to one another, this is not required.

Further, whereas a specific sintering regime is described, sintering of granular material of the type described in U.S. Pat. No. 7,083,758 is a matter of routine to persons of ordinary skill and variations are manifestly possible; all that is required is the avoidance of excessive rates of water vaporization and the avoidance of extreme temperature gradients, either of which can cause fracture.

Additionally, whereas a specific vibration rate and amplitude is specified, variations are manifestly possible, although filling rate may be compromised

Further, whereas a cordierite monolith is mentioned, the invention can be utilized with other honeycomb type substrates.

Accordingly, the invention should be understood as limited only by the accompanying claims, purposively construed.

What is claimed is:

1. A method for use with a substrate having a plurality of parallel channels extending therethrough, the method comprising the steps of:
filling a selected plurality of the channels with a granular material; and
consolidating the granular material through heat,
the selected plurality being selected to produce a wall that separates the substrate into:
a first portion having a first plurality of the parallel channels extending therethrough; and
a second portion having a second plurality of the parallel channels extending therethrough.

2. A method according to claim 1, wherein the granular material is sintered to produce the wall.

3. A method according to claim 1, wherein the granular material consists essentially of:
from 67 to 96% by weight of fly-ash comprising cenospheres,
from 2 to 15% by weight of a heat sensitive binder selected from the group consisting of boric acid and anhydrous boron oxide;
from 2 to 7% by weight of a non-wetting agent selected from the group consisting of calcium fluoride, magnesium fluoride and barium sulphate;
from 0 to 10% by weight of a heat expandable material selected from the group consisting of vermiculite and graphite; and
from 0 to 1% by weight of a dust suppressant.

4. A method according to claim 3, wherein the granular material consists essentially of:
from about 89.5% to 90% by weight of said fly ash;
about 8% by weight of said heat sensitive binder;
about 2% by weight of said non-wetting agent; and
from about 0 to 0.5% by weight of said dust suppressant.

5. The method according to claim 3, wherein the binder is boric acid.

6. The method according to claim 3, wherein the granular material contains 2 to 5 wt % of calcium fluoride.

7. The method according to claim 3, wherein the granular material has a density of from 25 to 30 lb/ft³.

8. A method according to claim 1, wherein the granular material has a median particle size of approximately 50 microns and a particle size ranging from 10 to 160 microns.

9. A method according to claim 8, wherein the filling step involves pouring the granular material into the selected plurality of the cells.

10. A method according to claim 9, wherein the substrate is vibrated during the filling process.

11. A method according to claim 6, wherein the vibration to which the substrate is subjected to during the filling step has an amplitude of about 10 millimeters and a speed of about 3 inch per second RMS.
